(19) United States
(12) Patent Application Publication
(10) Pub. No.: US 2023/0078558 A1
(43) Pub. Date: Mar. 16, 2023

(54) DISPLAY UNIT AND INCENTIVE OFFERING DEVICE

(71) Applicant: TOYOTA JIDOSHA KABUSHIKI KAISHA, Aichi-ken (JP)

(72) Inventors: Koseki SUGIYAMA, Sunto-gun (JP); Daiki YOKOYAMA, Gotemba-shi (JP)

(21) Appl. No.: 17/931,548

(22) Filed: Sep. 13, 2022

(30) Foreign Application Priority Data
Sep. 15, 2021 (JP) 2021-150379

(51) Int. Cl. G07C 5/12; G07C 5/08; G06Q 30/02

(52) U.S. Cl. CPC G07C 5/12; G07C 5/0825; G07C 5/0808; G06Q 30/0207

(57) ABSTRACT

A display unit that provides motivation to use energy derived from CO2. The display unit comprises: a data collector that collects an amount of the fuel derived from CO2 consumed by an operational device; a graphics data creator that creates a graphics data indicating the amount of the consumption of the fuel derived from CO2 based on the data collected by the data collector; and a display that indicates the graphics data created by the graphics data creator.

### CROSS-REFERENCE TO RELATED APPLICATIONS

The present disclosure claims the benefit of Japanese Patent Application No. 2021-150379 filed on Sep. 15, 2021 with the Japanese Patent Office.

### BACKGROUND

### Field of the Disclosure

Embodiments of the present disclosure relate to the art of a display unit and an incentive offering device for prompting the use of recycled fuel derived from carbon dioxide captured from the atmosphere.

### Discussion of the Related Art

JP-A-2021-24365 describes a display unit for indicating an amount of CO2 captured by a CO2 capturing device arranged in a vehicle. In the vehicle described in JP-A-2021-24365, CO2 contained in an exhaust gas is captured by the CO2 capturing device, and an amount of the captured CO2 is indicated in the display to provide motivation to use the vehicle having the CO2 capturing device.

Thus, in the vehicle described in JP-A-2021-24365, a driver or an owner of the vehicle is allowed to visually notice an amount of the captured CO2, and hence the driver or the owner is motivated to collect more CO2 from the exhaust gas. However, according to the teachings of JP-A-2021-24365, the driver or owner of the vehicle may not be motivated to recycle the captured CO2.

That is, if a massive amount of CO2 is emitted during the process of generating energy for propelling vehicles such as an electric power or gasoline, CO2 in the atmosphere may not be reduced sufficiently only by capturing CO2 from the exhaust gas.

### SUMMARY

Aspects of embodiments of the present disclosure have been conceived noting the foregoing technical problems, and it is therefore an object of the present disclosure to provide a display unit and an incentive offering device that provide motivation to use energy derived from CO2.

According to one aspect of the present disclosure, there is provided a display unit that urges a user of an operational device to use a recycled energy generated by burning a fuel derived from CO2 or mixing the fuel derived from CO2 with an ordinary fuel. In order to achieve the above-explained objective, according to one aspect of the present disclosure, the display unit is provided with a controller comprising: a data collector that collects data relating to an amount of consumption of the fuel derived from CO2 by the operational device operated by the recycled energy or a ratio of the fuel derived from CO2 in the recycled energy consumed by the operational device, and data relating to an amount of consumption of the ordinary fuel by the operational device operated by the recycled energy or a ratio of the ordinary fuel in the recycled energy consumed by the operational device; and a graphics data creator that creates a graphics data indicating the amount of the consumption of the fuel derived from CO2 or the ratio of the fuel derived from CO2 in the recycled energy, and the amount of the consumption of the ordinary fuel or the ratio of the ordinary fuel in the recycled energy, based on the data collected by the data collector. In addition, the display unit includes a display that indicates the graphics data created by the graphics data creator.

In a non-limiting embodiment, the data collector may include a calculator that calculates the amount of the consumption of the fuel derived from CO2 or the ratio of the fuel derived from CO2 in the recycled energy, and the amount of the consumption of the ordinary fuel or the ratio of the ordinary fuel in the recycled energy. v In a non-limiting embodiment, the data collector may include a receiver that receives the data relating to the amount of the consumption of the fuel derived from CO2 or the ratio of the fuel derived from CO2 in the recycled energy, and the data relating to the amount of the consumption of the ordinary fuel or the ratio of the ordinary fuel in the recycled energy from an external source.

In a non-limiting embodiment, the display may be configured to: indicate graphics to urge the user of the operational device to consume more fuel derived from CO2; and increase a period of time or a frequency to indicate the graphics to urge the user of the operational device to consume more fuel derived from CO2, with a reduction in the consumption of the fuel derived from CO2.

In a non-limiting embodiment, the graphics data creator may be configured to create an image of a plant that grows with an increase in the amount of the consumption of the fuel derived from CO2 or the ratio of the fuel derived from CO2 in the recycled energy.

In a non-limiting embodiment, the controller may further comprise a data receiver that receives data relating to amounts of consumption of the fuel derived from CO2 by other devices operated by the recycled energy or ratios of the fuel derived from CO2 in the recycled energy consumed by the other devices. In addition, the graphics data creator may be further configured to create a ranking list of the amounts of the consumption of the fuel derived from CO2 by the other devices and the operational device or a ranking list of the ratios of the fuel derived from CO2 in the recycled energy consumed by the other devices and the operational device, based on the data received by the data receiver and the data collected by the data collector.

According to another aspect of the present disclosure, there is also provided a display unit that urges a user of an operational device to use a recycled energy generated by burning a fuel derived from CO2 or mixing the fuel derived from CO2 with an ordinary fuel. In order to achieve the above-explained objective, according to another aspect of the present disclosure, the display unit is provided with a controller comprising: a data collector that collects data relating to an amount of consumption of the fuel derived from CO2 by the operational device operated by the recycled energy or a ratio of the fuel derived from CO2 in the recycled energy consumed by the operational device, and data relating to an amount of consumption of the ordinary fuel by the operational device operated by the recycled energy or a ratio of the ordinary fuel in the recycled energy consumed by the operational device; a data receiver that receives data relating to amounts of consumption of the fuel derived from CO2 by other devices operated by the recycled energy or ratios of the fuel derived from CO2 in the recycled energy consumed by the other devices; and a graphics data creator that creates a ranking list of the amounts of the consumption of the fuel derived from CO2 by the other devices and the operational device or a ranking list of the ratios of the fuel derived from CO2 in the recycled energy consumed by the other devices and the operational device, based on the data received by the data receiver and the data collected by the data collector. In addition, the display unit includes a display that indicates the ranking list created by the graphics data creator.

In a non-limiting embodiment, the controller may further comprise: a comparator that compares the amounts of the consumption of the fuel derived from CO2 by the other devices with the amount of the consumption of the fuel derived from CO2 by the operational device, or that compares the ratios of the fuel derived from CO2 in the recycled energy consumed by the other devices with the ratio of the fuel derived from CO2 in the recycled energy consumed by the operational device; and a sorter that sorts the amounts of the consumption of the fuel derived from CO2 by the other devices and the operational device, or that sorts the ratios of the fuel derived from CO2 in the recycled energy consumed by the other devices and the operational device. In addition, the graphics data creator may be configured to create the ranking list based on the items sorted by the sorter.

In a non-limiting embodiment, the recycled energy may include an electric power generated by burning the fuel derived from CO2 and the ordinary fuel.

According to still another aspect of the present disclosure, there is also provided an incentive offering device that urges a user or an owner of an operational device to use a recycled energy generated by burning a fuel derived from CO2 or mixing the fuel derived from CO2 with an ordinary fuel. In order to achieve the above-explained objective, according to still another aspect of the present disclosure, the display unit is provided with a controller comprising: a data collector that collects data relating to an amount of consumption of the fuel derived from CO2 by the operational device operated by the recycled energy or a ratio of the fuel derived from CO2 in the recycled energy consumed by the operational device, and data relating to an amount of consumption of the ordinary fuel by the operational device operated by the recycled energy or a ratio of the ordinary fuel in the recycled energy consumed by the operational device; and an incentive transmitter that offers an incentive to the user or the owner of the operational device in accordance with the amount of the consumption of the fuel derived from CO2 collected by the data collector, or in accordance with the ratio of the fuel derived from CO2 in the recycled energy collected by the data collector.

Thus, according to one aspect of the present disclosure, graphics data indicating the consumption of the fuel derived from CO2 by the operational device is indicated on the display. According to one aspect of the present disclosure, therefore, the user of the operational device is allowed to visually notice the amount of the consumption of the fuel derived from CO2. For this reason, the user of the operational device is motivated to use the fuel derived from CO2, and as a result, CO2 in the atmosphere may be reduced.

According to another aspect of the present disclosure, a ranking list of the amounts of the consumption of the fuel derived from CO2 by other devices and the operational device is indicated on the display. According to another aspect of the present disclosure, therefore, the user of the operational device is motivated to consume more fuel derived from CO2 so as to compete with other users of the fuel derived from CO2. For this reason, CO2 in the atmosphere may be further reduced.

According to still another aspect of the present disclosure, the incentive transmitter offers an incentive compensation to the user of the operational device in accordance with e.g., an amount of consumption of the fuel derived from CO2. According to still another aspect of the present disclosure, therefore, the user of the operational device is strongly motivated to use more fuel derived from CO2. For this reason, CO2 in the atmosphere may be reduced effectively.

### BRIEF DESCRIPTION OF THE DRAWINGS

Features, aspects, and advantages of exemplary embodiments of the present disclosure will become better understood with reference to the following description and accompanying drawings, which should not limit the disclosure in any way.

FIG. 1 is an explanation drawing showing one example of a system of supplying recycled energy to vehicles and electric devices;

FIG. 2 is a block diagram showing one example of a structure of a display unit;

FIG. 3 is a flowchart showing one example of a routine executed by a controller of a recycled energy generating facility;

FIG. 4 is a flowchart showing one example of a routine executed by a server;

FIG. 5 is a flowchart showing another example of a routine executed by a server;

FIG. 6 is a flowchart showing one example of a routine executed by a display unit;

FIG. 7 is a pie chart indicating a ratio between consumption of a fuel derived from O2 and consumption of an ordinary fuel;

FIGS. 8A to 8D are examples of graphics indicating an increase in the consumption of the fuel derived from CO2;

FIG. 9 is an illustration showing one example of a messages to urge a user of an operational device to consume more fuel derived from CO2;

FIG. 10 is a block diagram showing another example of a structure of a display unit;

FIG. 11 is an illustration showing one example of a ranking list of registered users of the fuel derived from CO2;

FIG. 12 is a block diagram showing one example of a structure of an incentive offering device; and

FIG. 13 is a flowchart showing an example of a routine executed by the incentive offering device.

### DETAILED DESCRIPTION OF THE PREFERRED EMBODIMENT(S)

Embodiments of the present disclosure will now be explained with reference to the accompanying drawings. Note that the embodiments shown below are merely examples of the present disclosure which should not limit a scope of the present disclosure.

The display unit and the incentive offering device according to the exemplary embodiment of the present disclosure are configured to accelerate the use of recycled fuel derived from CO2. For example, the fuel derived from CO2 may be mixed with a liquid fuel to be used as a fuel for propelling vehicles. The fuel derived from CO2 may also be used as a fuel to generate an electric power to operate electric devices for home use.

For example, CO2 may be recycled into fuel utilizing hydrocarbon compounds generated in cells of algae as a result of photosynthesis of algae. Therefore, CO2 captured by a CO2 capturing device from the atmosphere or exhaust gas may be recycled into fuel by supplying the captured CO2 to algae in a habitat possible to carry on photosynthesis.

Otherwise, CO2 may also be recycled into fuel by other kinds of techniques. For example, CO2 may also be recycled into liquid synfuel by synthesizing CO2 with hydrogen.

The fuel derived from CO2 may be mixed with other kinds of fuels such as petroleum, coal, natural gas etc. For example, the fuel derived from CO2 may be mixed with gasoline to be used as liquid fuel to propel vehicles. Otherwise, the fuel derived from CO2 may also be mixed with petroleum or coal to be used as a fuel to generate electricity. In this case, thermal energy generated by burning the fuel is translated into electric energy, and the electric power (i.e., electricity) is supplied to housings to operate electric devices. According to the embodiment of the present disclosure, therefore, a recycled energy includes the liquid fuel derived from CO2 and the electric power generated by burning the fuel derived from CO2, and an operational device to be operated by the recycled energy includes vehicles and electric devices.

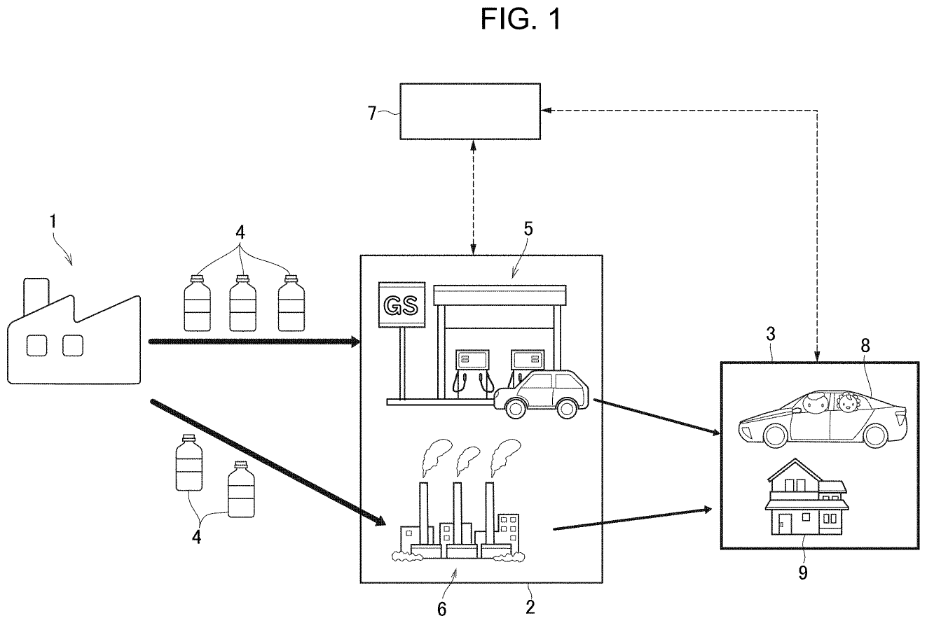

Turning now to FIG. 1, there is shown one example of a system for supplying the recycled energy of the vehicles and electric devices. The system shown in FIG. 1 comprises a CO2 recycling facility 1, a recycled energy generating facility 2, and the operational device 3.

For example, CO2 captured by the CO2 capturing devices installed in e.g., housings are delivered to the CO2 recycling facility 1 via a pipeline (not shown). In addition, CO2 captured by the CO2 capturing devices mounted on vehicles are delivered to the CO2 recycling facility 1 by the vehicles.

The CO2 delivered to the CO2 recycling facility 1 is recycled into a fuel 4 utilizing photosynthesis of algae, or mixed with hydrogen to be used as the fuel 4.

The fuel 4 recycled from the captured CO2 by the CO2 recycling facility 1 is delivered to the recycled energy generating facility 2 to be translated into energy to operate the operational device 3. According to the exemplary embodiment of the present disclosure, the recycled energy generating facility 2 includes a gas station 5 and a thermal energy plant 6. That is, the fuel 4 recycled from the captured CO2 by the CO2 recycling facility 1 is partially delivered to the gas station 5, and the remaining fuel 4 is delivered to the thermal energy plant 6.

The fuel 4 delivered to the gas station 5 is mixed with a fuel stored in a tank of the gas station 5. Specifically, a fuel as a mix of gasoline and the fuel 4 derived from CO2 which has been delivered to the gas station 5 is held in the tank of the gas station 5. For example, data about a remaining amount of the fuel in the tank, and data about a concentration of the fuel 4 derived from CO2 in the fuel stored in the tank are sent to a server 7 of a network. Those data items stored in the server 7 are updated continually when e.g., delivering the fuel 4 to the gas station 5.

Whereas, the fuel 4 delivered to the thermal energy plant 6 is mixed with an ordinary fuel used in the thermal energy plant 6 such as petroleum, diesel, and coal, and the fuel as a mix of the ordinary fuel and the fuel 4 is burnt to generate electricity. Thus, in the thermal energy plant 6, thermal energy generated by burning the fuel is translated into electric energy. That is, as a result of consuming the electric energy thus generated by burning the fuel containing the fuel 4 derived from CO2, the fuel 4 derived from CO2 is also consumed. For example, data about an amount of the fuel 4 consumed to generate the electricity, and data about a ratio of the fuel 4 consumed to generate the electricity to the electricity generated by burning the fuel containing the fuel 4 (also referred to as “consumption ratio” hereinafter) are sent to the server 7. In other words, data relating to an amount of consumption of the fuel 4 derived from CO2 by the operational device 3 operated by the recycled energy, and data relating to a ratio of the fuel 4 derived from CO2 in the recycled energy consumed by the operational device 3 are sent to the server 7.

The fuel and the electricity recycled by the recycled energy generating facility 2 are supplied to vehicles 8 and electric devices 9 for home use. Specifically, a liquid fuel as a mix of gasoline or diesel and the fuel 4 derived from CO2 is supplied from the gas station 5 to the vehicles 8 having internal combustion engines. Whereas, the electricity generated by the thermal energy plant 6 is supplied to electric vehicles 8 at home or at a charging station, and also supplied to electric devices 9 for home use.

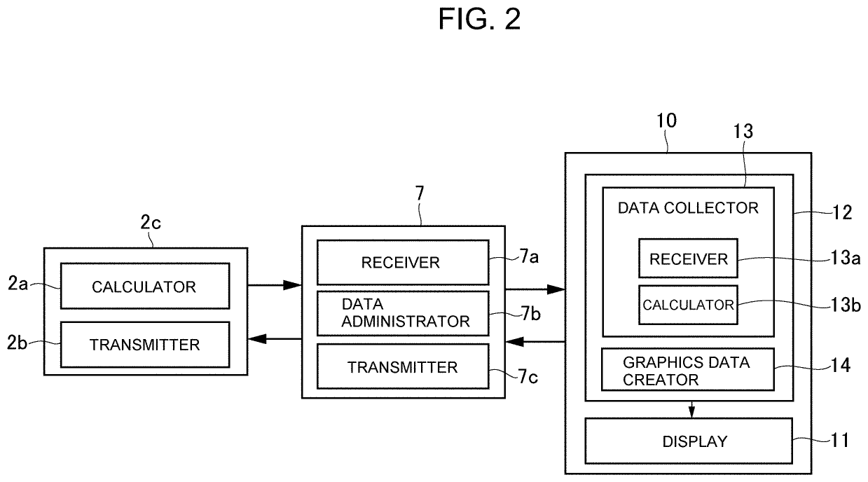

An amount of the fuel 4 consumed by the operational device 3 and a ratio of the fuel 4 in the recycled energy consumed by the operational device 3 may be indicated on a display so that a user of the vehicle 8 or the electric device 9 is allowed to visually notice those data items. Turning to FIG. 2, there is shown one example of a structure of a display unit 10. As illustrated in FIG. 2, the display unit 10 comprises a display 11 on which the data relating to e.g., consumption of the fuel 4 is indicated, and a controller 12 that creates a graphics data to be indicated on the display 11.

For example, in the vehicle 8, a display of a navigation system may serve as the display 11. The display 11 may also be installed in the electric device 9, or mounted on a wall of a housing where the electric device 9 is installed or used. Otherwise, a mobile terminal such as a smartphone may also be adopted as the display 11. Thus, according to the exemplary embodiment of the present disclosure, the display unit 10 may not only be integrated with the operational device 3, but different kinds of indicator may also be adopted as the display 11.

As shown in FIG. 2, the controller 12 comprises a data collector 13 that collects data relating to consumption of the fuel 4 or the above-mentioned consumption ratio of the fuel 4, and a graphics data creator 14 that creates a graphics data to be indicated on the display 11 based on the data collected by the data collector 13.

That is, the data collector 13 collects data necessary to create the graphics data by the graphics data creator 14. To this end, specifically, the data collector 13 collects at least one of data relating to an amount of the fuel 4 consumed by the operational device 3, and data relating to a ratio of the fuel 4 in the recycled energy consumed by the operational device 3. Otherwise, the data collector 13 may also calculate the above-mentioned data items based on the collected data.

For example, an amount of the fuel 4 consumed by the vehicle 8 may be calculated by an electronic control unit (to be abbreviated as ECU hereinafter) of the vehicle 8. Specifically, an amount of the fuel 4 consumed by the vehicle 8 may be calculated by: multiplying a concentration of the fuel 4 in the liquid fuel consumed by the vehicle 8, by an amount of the fuel consumed by the vehicle 8. The amount of the fuel 4 consumed by the vehicle 8 thus calculated by the ECU is collected by the data collector 13.

In order to obtain an amount of the fuel 4 consumed by the electric device 9, the controller 12 collects the following data from the server 7 such as: data relating to an amount of electricity supplied from the thermal energy plant 6 to the electric device 9; and data relating to consumption of the fuel 4 per unit electric power at the time when the electricity consumed by the electric device 9 was generated by the thermal energy plant 6. Then, the amount of the fuel 4 consumed of by the electric device 9 is calculated by multiplying the amount of electricity supplied to the electric device 9 by the consumption of the fuel 4 per unit electric power. In order to collect the above-explained data relating to an amount of consumption of the fuel 4, the data collector 13 is provided with a receiver 13a that receive data from an external source, and a calculator 13b that calculates an amount of consumption of the fuel 4. Specifically, the calculator 13b is configured to calculate an amount of the fuel 4 consumed by the operational device 3 operated by the recycled energy, or a ratio of the fuel 4 derived from CO2 in the recycled energy consumed by the operational device 3.

In addition, the calculator 13b of the data collector 13 also calculates an amount of the ordinary fuel consumed by the operational device 3 operated by the recycled energy, or a ratio of the ordinary fuel in the recycled energy consumed by the operational device 3. For example, the calculator 13b also calculates an amount of the ordinary fuel consumed to generate the electricity, and a ratio of the ordinary fuel consumed to generate the electricity to the electricity generated by burning the fuel as a mix of the ordinary fuel and the fuel 4 (i.e., the consumption ratio).

The recycled energy generating facility 2 comprises a controller 2c. Specifically, the controller 2c comprises: a calculator 2a that calculates an amount of the recycled energy supplied to the operational device 3, and an amount of the fuel 4 derived from CO2 burnt to generate the recycled energy or mixed with the ordinary fuel; and a transmitter 2b that transmits calculation results of the calculator 2a to the server 7.

In the server 7, data transmitted from the recycled energy generating facility 2 is received by a receiver 7a. Specifically, the receiver 7a of the server 7 receives data relating to an amount of the recycled energy supplied to the operational device 3, and data relating to an amount of the fuel 4 consumed to generate the recycled energy or mixed with the ordinary fuel.

The server 7 further comprises a data administrator 7b and a transmitter 7c. Specifically, the data administrator 7b administrates the operational device 3 in connection with an amount of the recycled energy supplied to the operational device 3, and an amount of the fuel 4 consumed to generate the recycled energy. For example, the following data items are transmitted from the transmitter 7c, such as: data relating to an amount of the recycled energy supplied from the recycled energy generating facility 2 to the operational device 3; data relating to an amount of the fuel 4 consumed to generate the recycled energy supplied from the recycled energy generating facility 2 to the operational device 3; and data relating to an amount of the fuel 4 mixed with the ordinary fuel burnt to generate the recycled energy supplied from the recycled energy generating facility 2 to the operational device 3.

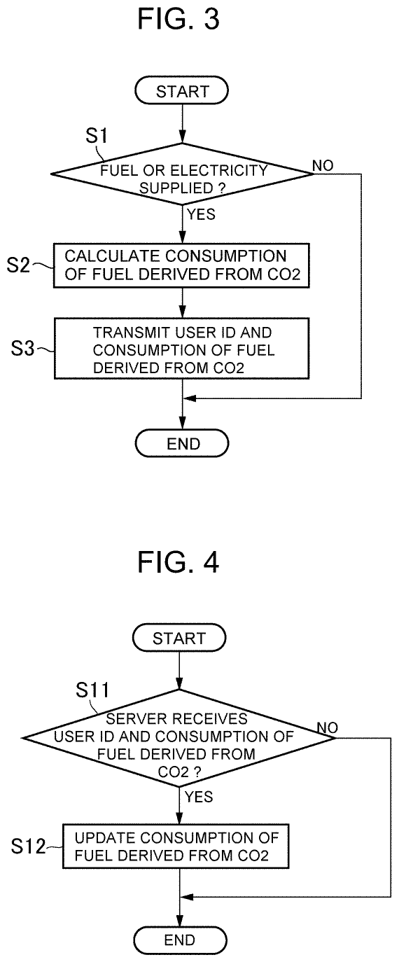

Next, here will be explained examples of routines executed by the recycled energy generating facility 2, the server 7, and the display unit 10. Turning to FIG. 3, there is shown one example of a routine executed by the controller 2c of the recycled energy generating facility 2. At step S1, it is determined whether the fuel or the electricity is supplied to the operational device 3. For example, the answer of step S1 will be YES if not only the fuel as a mix of the fuel 4 and the ordinary fuel but also any one of the fuel 4 and the ordinary fuel is supplied from the gas station 5 to the vehicle 8. Likewise, the answer of step S1 will also be YES if not only the electricity generated by burning the fuel as a mix of the fuel 4 and the ordinary fuel, but also the electricity generated by burning any one of the fuel 4 and the ordinary fuel, is supplied from the thermal energy plant 6 to the electric device 9 or the electric vehicle 8.

If none of the fuel or the electricity is supplied to the operational device 3 so that the answer of step S1 is NO, the routine returns. By contrast, if the fuel or the electricity is supplied to the operational device 3 so that the answer of step S1 is YES, the routine progresses to step S2 to calculate consumption of the fuel 4 derived from CO2. Specifically, in a case that the fuel is supplied from the gas station 5 to the vehicle 8, consumption of the fuel 4 is calculated by multiplying a concentration of the fuel 4 in the liquid fuel stored in the tank of the gas station 5 by an amount of the liquid fuel supplied from the gas station 5 to the vehicle 8. Whereas, in a case that the electricity is supplied from the thermal energy plant 6 to e.g., the electric device 9, consumption of the fuel 4 is calculated by dividing a total amount of the fuel 4 consumed by the thermal energy plant 6 at the time when the electricity is supplied to the electric device 9 by an amount of the electricity supplied to the electric device 9. If only the ordinary fuel is supplied to the vehicle 8, or if the electricity generated by burning only the ordinary fuel is supplied to e.g., the electric device 9, the consumption of the fuel 4 is zero.

At step S3, data relating to a user ID allotted to a user of the operational device 3 and data relating to the consumption of the fuel 4 are sent to the server 7, and thereafter the routine returns. Specifically, the recycled energy generating facility 2 authenticates the user ID by specifying a supply destination of the recycled energy at the time when the recycled energy is supplied to the operational device 3. In addition, data relating to the consumption of the ordinary fuel may be sent to the server 7. Otherwise, consumption ratios of the fuel 4 and the ordinary fuel may also be sent to the server 7 instead of the consumption of the fuel 4.

Turning to FIG. 4, there is show one example of a routine executed by the server 7. At step S11, it is determined whether the server 7 has received the data relating to the user ID and the data relating to the consumption (or the consumption ratio) of the fuel 4 are sent to the server 7 from the recycled energy generating facility 2. If the server 7 has not yet received the above-mentioned data items so that the answer of step S11 is NO, the routine returns. By contrast, if the server 7 the answer of step S11 is YES, the routine progresses to step S12 to update the data relating to the user ID and the data relating to the consumption of the fuel 4, and thereafter returns.

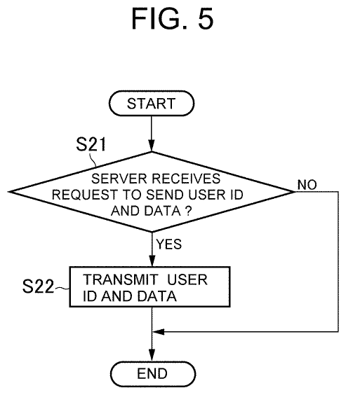

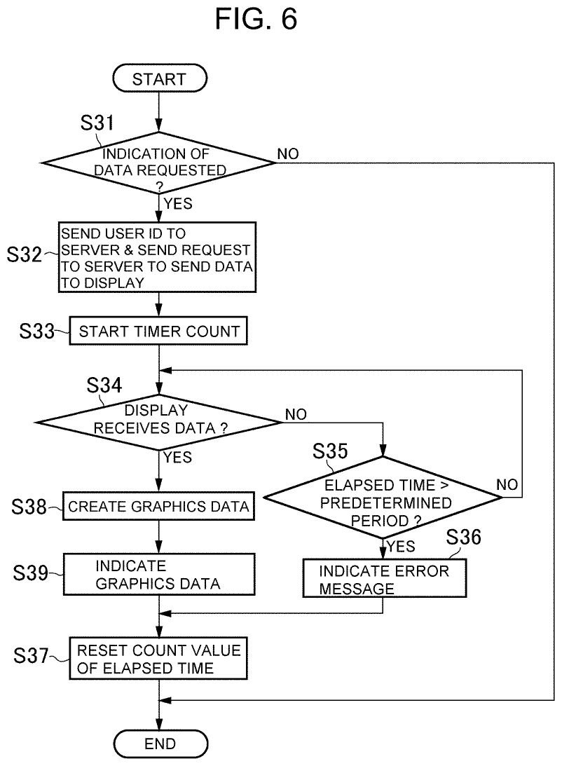

In order to exchange data between the server 7 and the display unit 10, the server 7 also executes a routine shown in FIG. 5. At step S21, it is determined whether the server 7 has received a request to send the user ID and the data relating to the consumption of the fuel 4 from the display unit 10 (at the after-mentioned step S32 of the routine shown in FIG. 6).

If the server 7 has not yet received the request to send the user ID and the data relating to the consumption of the fuel 4 to the display unit 10 so that the answer of step S21 is NO, the routine returns. By contrast, if the server 7 has received the request to send the user ID and the data relating to the consumption of the fuel 4 to the display unit 10 so that the answer of step S21 is YES, the routine progresses to step S22. At step S22, the server 7 collects the user ID of the user of the operational device 3 and the data relating to the consumption of the fuel 4 by the user from the data administrator 7b. Thereafter, the routine returns.

Turning to FIG. 6, there is show one example of a routine executed by the display unit 10. At step S31, it is determined whether the data relating to the consumption of the fuel 4 is requested to be indicated on the display 11. For example, such determination at step S31 may be made based on a fact that an indication button is clicked, or that a power switch is turned on.

If the indication of data is not requested so that the answer of step S31 is NO, the routine returns. By contrast, if the indication of data is requested so that the answer of step S31 is YES, the routine progresses to step S32. At step S32, the user ID of the user of the operational device 3 is transmitted from the operational device 3 to the server 7, and the display unit 10 sends a request to the server 7 to send the data relating to the consumption of the fuel 4 by the user to the display unit 10. Then, the routine progresses to step S33 to start measurement of an elapsed time from a point at which the request to send the data is transmitted from the display unit 10.

Thereafter, it is determined at step S34 whether the display unit 10 has received the data relating to the consumption of the fuel 4 by the user of the operational device 3 from the server 7. If the display unit 10 has not yet received the data so that the answer of step S34 is NO, the routine progresses to step S35 to determine whether a count value of the elapsed time is longer than a predetermined period of time. Specifically, if the measured elapsed time is longer than the predetermined period of time, the display unit 10 determines that the operational device 3 having the display unit 10 or the display unit 10 is in an environment where the data cannot be exchanged between the server 7 and the display unit 10. Therefore, if the measured elapsed time is shorter than the predetermined period of time so that the answer of step S35 is NO, the routine returns to step S34 to repeat the determination at step S34 until the display unit 10 receives the data or until the elapsed time exceeds the predetermined period of time. By contrast, if the measured elapsed time is longer than the predetermined period of time so that the answer of step S35 is YES, the routine progresses to step S36 to indicate an error message on the display 11. Thereafter, the count value of the elapsed time is reset at step S37, and the routine returns.

By contrast, if the display unit 10 has received the data so that the answer of step S34 is YES, the routine progresses to step S38 to create a graphics data to be indicated on the display 11, and further progresses to step S39 to indicate the graphics data on the display 11. Thereafter, the count value of the elapsed time is reset at step S37, and the routine returns.

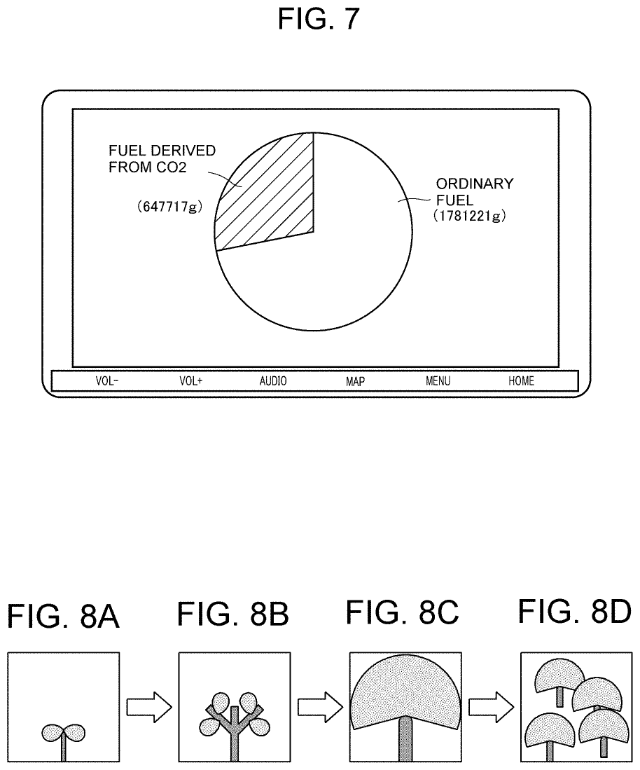

For example, as depicted in FIG. 7, a pie chart is created at step S38 to indicate a ratio between consumption of the fuel 4 derived from CO2 and consumption of the ordinary fuel on the display 11. To this end, at step S38, the display unit 10 obtains data relating to consumption of the fuel 4 and data relating to consumption of the ordinary fuel from the server 7, and calculates the ratio between the consumption of the fuel 4 and the consumption of the ordinary fuel.

For example, in order to create the graphics data at step S38, consumption of the fuel 4 by the vehicle 8 may be calculated on the basis that the vehicle 8 consumed the fuel 4 contained in the liquid fuel supplied from the gas station 5, even if the vehicle 8 did not actually consume the fuel 4. Otherwise, the consumption of the fuel 4 may also be calculated based on an actual fuel consumption of the vehicle 8. To this end, the display unit 10 obtains the following data from the ECU of the vehicle 8, such as: an amount of the liquid fuel remaining in the tank of the vehicle 8 before supplying the liquid fuel containing the fuel 4 to the vehicle 8; and a concentration of the fuel 4 in the liquid fuel remaining in the tank. Then, the display unit 10 obtains the following data from the server 7, such as: an amount of the liquid fuel supplied to the vehicle 8 from the gas station 5; and an amount of the fuel 4 contained in the liquid fuel supplied to the vehicle 8 from the gas station 5. Then, a concentration (i.e., a ratio) of the fuel 4 contained in the liquid fuel in the tank after supplying the liquid fuel to the vehicle 8 from the gas station 5 is calculated based on the amount of the liquid fuel supplied to the vehicle 8 and the amount of the fuel 4 contained in the liquid fuel. Thereafter, the consumption of the fuel 4 by the vehicle 8 is calculated by multiplying the fuel consumption of the vehicle 8 by the concentration (i.e., the ratio) of the fuel 4 contained in the liquid fuel in the tank after supplying the liquid fuel to the vehicle 8.

Another example of the graphics indicated on the display 11 of the display unit 10 is shown in FIGS. 8A to 8D. As depicted in FIGS. 8A to 8D, images that make the user (or driver) of the operational device 3 imagine that a global environment is improved with consumption of CO2 such as a plant may also be indicated on the display 11. For example, in a case of indicating an image of a tree on the display 11 as depicted in FIGS. 8A to 8D, the tree grows with an increase in consumption of the fuel 4 derived from CO2. In this case, the tree comes out when the user starts consuming the fuel 4 as depicted in FIG. 8A, and branches grow with an increase in the consumption of the fuel 4 as depicted in FIG. 8B. The tree growth thick with a further increase in the consumption of the fuel 4 as depicted in FIG. 8C, and eventually, the number of trees increases with a further increase in the consumption of the fuel 4 as depicted in FIG. 8D. Thus, in the example shown in FIG. 8, an increase in the consumption of the fuel 4 is indicated at four phases. However, an increase in the consumption of the fuel 4 may also be indicated at five or more phases. For example, an increase in the consumption of the fuel 4 may also be indicated by changing a degree of clearness of air or clouds, or by changing a scale of a glacier of the South Pole or the North Pole.

Thus, an amount of consumption of the fuel 4 derived from CO2 is indicated on the display 11 so that the user of the operational device 3 is allowed to visually notice the amount of consumption of the fuel 4. According to the exemplary embodiment of the present disclosure, therefore, the user of the operational device 3 is motivated to use the fuel 4 derived from CO2. Consequently, CO2 in the atmosphere may be reduced.

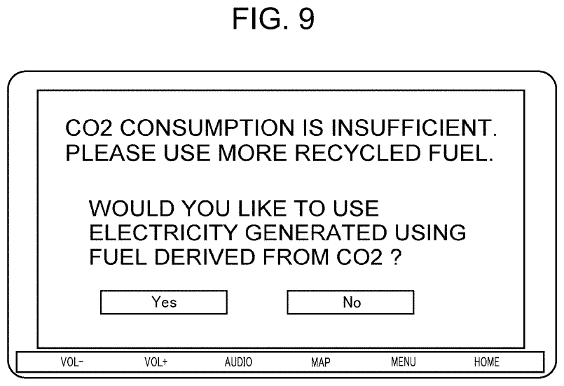

When the consumption of the fuel 4 derived from CO2 is small, for example, messages shown in FIG. 9 may be indicated on the display 11 to urge the user of the operational device 3 to consume more fuel 4 derived from CO2. In this situation, it is preferable to increase a period of time or a frequency to indicate such messages with a reduction in the consumption of the fuel 4. In addition, if another recycled energy possible to consume more CO2 (e.g., an electric power) is available, a message to urge the user of the operational device 3 to switch the energy to operate the operational device 3 to such another recycled energy

By thus indicating the message to urge the user of the operational device 3 to consume more CO2, the user of the operational device 3 is further motivated to use the fuel 4 derived from CO2.

In addition, a ranking list of consumption of the fuel 4 by registered users or a ranking list of consumption ratio of the fuel 4 in the liquid fuel consumed by the registered users may also be indicated on the display 11, in addition to or instead of the above-mentioned graphics indicating consumption of the fuel 4.

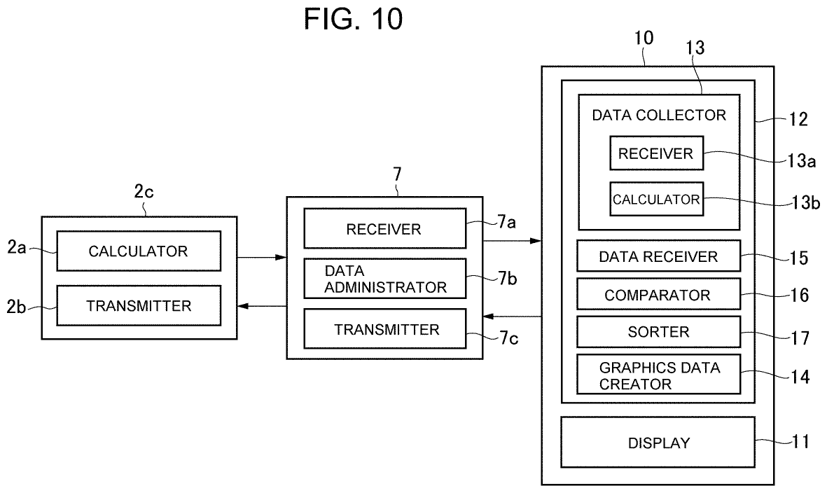

Turning to FIG. 10, there is shown another example of a structure of the display unit 10 to indicate the ranking of the registered users (i.e., consumers) of the fuel 4. According to another example, the display unit 10 comprises the display 11 and the controller 12, and the controller 12 comprises the data collector 13, the graphics data creator 14, and a data receiver 15. Specifically, the data receiver 15 receives data relating to amounts of consumption of the fuel 4 by other registered users operating other devices using the recycled energy, and data relating to ratios of the fuel 4 in the recycled energy consumed by other registered users. To this end, user IDs of the registered users are administrated by the server 7.

According to another example, the controller 12 further comprises: a comparator 16 that compares amounts of the fuel 4 consumed by other devices operated by other registered users with an amount of the fuel 4 consumed by the operational device 3, or that compares ratios of the fuel 4 in the recycled energy consumed by other devices operated by other registered users with a ratio of the fuel 4 in the recycled energy consumed by the operational device 3; and a sorter 17 that sorts the amounts of the fuel 4 consumed by other devices and the operational device 3, or that sorts the ratios of the fuel 4 in the recycled energy consumed by other devices and the operational device 3, in order of the amount of consumption of the fuel 4 based on a result of the comparison made by the comparator 16. Given that the server 7 has the functions of the comparator 16 and the sorter 17, the comparator 16 and the sorter 17 may be omitted form the controller 12.

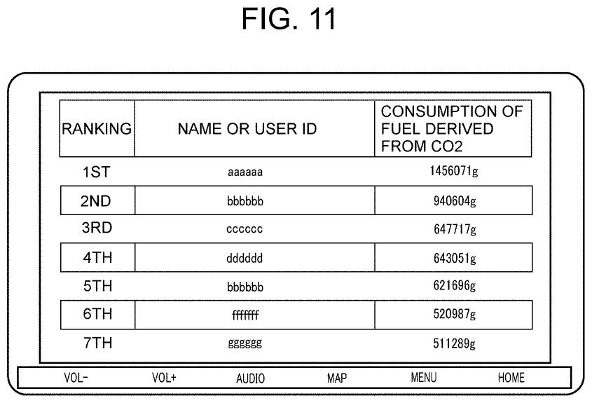

In order to indicate the ranking of consumption of the fuel 4 on the display 11, the display unit 10 sends a request to the server 7 at step S32 to send data relating to the consumptions and the above-mentioned consumption ratios of the fuel 4 concerning other users of the fuel 4 to the display unit 10, and the sorter 17 sorts the amounts of consumption or the consumption ratios of the fuel 4 based on a result of the comparison made by the comparator 16. An example of the ranking indicated on the display 11 is shown in FIG. 11.

By thus indicating the ranking list of consumption of the fuel 4, the user of the operational device 3 is motivated to compete with other registered users to consume more fuel 4 derived from CO2.

Next, here will be explained the incentive offering device according to the exemplary embodiment of the present disclosure. In order to motivate the user (or owner) of the operational device 3 to use the recycled energy such as the fuel 4, according to the exemplary embodiment of the present disclosure, the incentive offering device is configured to offer an incentive to the user of the operational device 3 in accordance with an amount of consumption or a consumption ratio of the fuel 4.

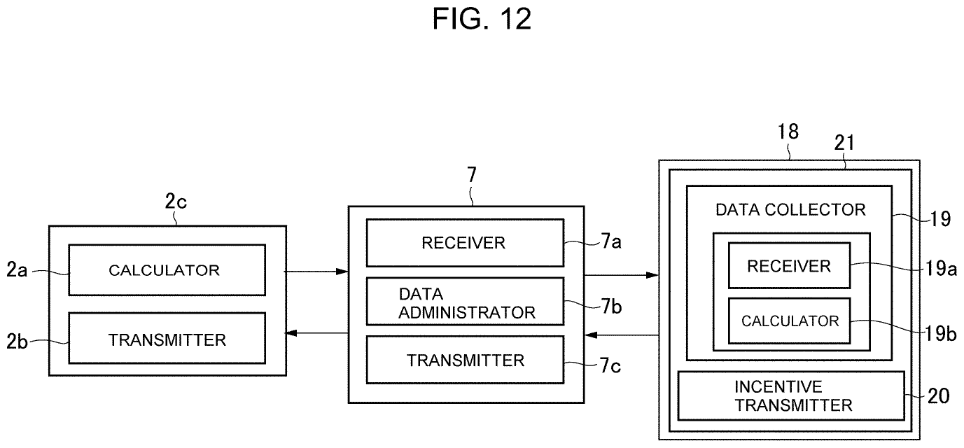

Turning to FIG. 12, there is shown one example of a structure of the incentive offering device 18 that offers an incentive to the user of the operational device 3. As the display unit 10 according to foregoing examples, the incentive offering device 18 shown in FIG. 12 is also adapted to communicate with the server 7. A controller 21 of the incentive offering device 18 comprises: a data collector 19 that collects at least one of data relating to an amount of the fuel 4 consumed by the operational device 3 operated by the recycled energy, and a ratio of the fuel 4 in the recycled energy consumed by the operational device 3; and an incentive transmitter 20 that transmits an incentive compensation to the user (or owner) of the operational device 3 based on the data collected by the data collector 19.

Thus, the data collector 19 is configured to collect data necessary to calculate an incentive compensation to be transmitted to the user (or owner) of the operational device 3, and calculates at least one of an amount of the fuel 4 consumed by the operational device 3 operated by the recycled energy and a ratio of the fuel 4 in the recycled energy consumed by the operational device 3 based on the collected data. That is, the data collector 19 has same functions as the data collector 13 of the display unit 10 according to the foregoing examples. Accordingly, the data collector 19 also comprises a receiver 19a that receive data from the external sources such as the ECU of the vehicle 8 and the server 7, and a calculator 19b that calculates an amount of consumption of the fuel 4.

The incentive transmitter 20 is configured to calculate an incentive compensation to be offered to the user (or owner) of the operational device 3 based on the data collected by the data collector 19, and to transmit the calculated incentive compensation to e.g., the server 7. For example, the incentive compensation may be a financial compensation such as a discount for changing oil.

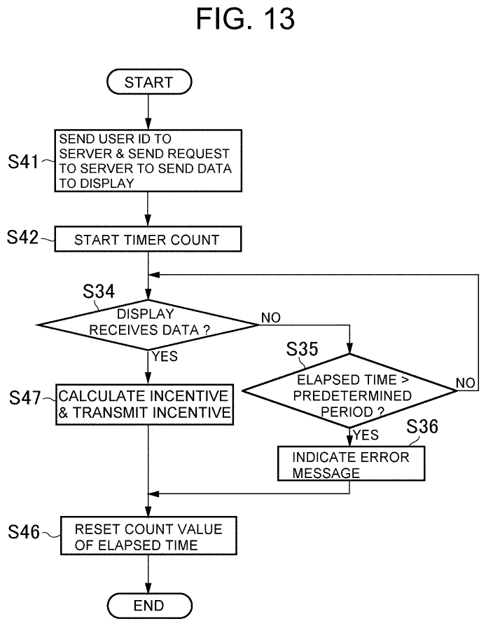

Turning to FIG. 13, there is shown one example of a routine executed by the incentive offering device 18. At step S41, a user ID of the user (or owner) of the operational device 3 is transmitted from the operational device 3 to the server 7, and the incentive offering device 18 sends a request to the server 7 to send the data relating to the consumption of the fuel 4 by the user to the incentive offering device 18. Then, the routine progresses to step S42 to start measurement of an elapsed time from a point at which the request to send the data is transmitted from the incentive offering device 18.

Thereafter, it is determined at step S43 whether the incentive offering device 18 has received the requested data from the server 7. If the incentive offering device 18 has not yet received the data so that the answer of step S43 is NO, the routine progresses to step S44 to determine whether a count value of the elapsed time is longer than a predetermined period of time. Specifically, if the measured elapsed time is longer than the predetermined period of time, the incentive offering device 18 determines that the operational device 3 having the incentive offering device 18 or the incentive offering device 18 is in an environment where the data cannot be exchanged between the server 7 and the incentive offering device 18. Therefore, if the measured elapsed time is shorter than the predetermined period of time so that the answer of step S44 is NO, the routine returns to step S43 to repeat the determination at step S43 until the incentive offering device 18 receives the data or until the elapsed time exceeds the predetermined period of time. By contrast, if the measured elapsed time is longer than the predetermined period of time so that the answer of step S44 is YES, the routine progresses to step S45 to indicate an error message on the display 11. Thereafter, the count value of the elapsed time is reset at step S46, and the routine returns.

By contrast, if the incentive offering device 18 has received the data so that the answer of step S43 is YES, the routine progresses to step S47 to calculate an incentive compensation based on the data transmitted from the server 7, and to transmit the calculated incentive compensation to the server 7. Thereafter, the count value of the elapsed time is reset at step S46, and the routine returns.

At step S47, specifically, the incentive compensation is calculated based on an amount of the fuel 4 consumed by the operational device 3 operated by the recycled energy, or a ratio of the fuel 4 in the recycled energy consumed by the operational device 3. That is, the incentive compensation to be transmitted to the user may be calculated by the procedures of step S38 of the routine shown in FIG. 6.

Thus, according to the exemplary embodiment of the present disclosure, the incentive offering device 18 offers an incentive compensation to the user of the operational device 3 in accordance with consumption of the fuel 4 derived from CO2. According to the exemplary embodiment of the present disclosure, therefore, the user of the operational device 3 is strongly motivated to use more fuel 4 derived from CO2. Consequently, CO2 in the atmosphere may be reduced effectively.

What is claimed is:

1. A display unit that urges a user of an operational device to use a recycled energy generated by burning a fuel derived from CO2 or mixing the fuel derived from CO2 with an ordinary fuel, comprising:
a controller comprising
a data collector that collects data relating to an amount of consumption of the fuel derived from CO2 by the operational device operated by the recycled energy or a ratio of the fuel derived from CO2 in the recycled energy consumed by the operational device, and data relating to an amount of consumption of the ordinary fuel by the operational device operated by the recycled energy or a ratio of the ordinary fuel in the recycled energy consumed by the operational device, and
a graphics data creator that creates a graphics data indicating the amount of the consumption of the fuel derived from CO2 or the ratio of the fuel derived from CO2 in the recycled energy, and the amount of the consumption of the ordinary fuel or the ratio of the ordinary fuel in the recycled energy, based on the data collected by the data collector; and
a display that indicates the graphics data created by the graphics data creator.

2. The display unit as claimed in claim 1, wherein the data collector includes a calculator that calculates the amount of the consumption of the fuel derived from CO2 or the ratio of the fuel derived from CO2 in the recycled energy, and the amount of the consumption of the ordinary fuel or the ratio of the ordinary fuel in the recycled energy.

3. The display unit as claimed in claim 1, wherein the data collector includes a receiver that receives the data relating to the amount of the consumption of the fuel derived from CO2 or the ratio of the fuel derived from CO2 in the recycled energy, and the data relating to the amount of the consumption of the ordinary fuel or the ratio of the ordinary fuel in the recycled energy from an external source.

4. The display unit as claimed in claim 1, wherein the display is configured to:
indicate graphics to urge the user of the operational device to consume more fuel derived from CO2; and
increase a period of time or a frequency to indicate the graphics to urge the user of the operational device to consume more fuel derived from CO2, with a reduction in the consumption of the fuel derived from CO2.

5. The display unit as claimed in claim 1, wherein the graphics data creator is configured to create an image of a plant that grows with an increase in the amount of the consumption of the fuel derived from CO2 or the ratio of the fuel derived from CO2 in the recycled energy

6. The display unit as claimed in claim 1, wherein the controller further comprises a data receiver that receives data relating to amounts of consumption of the fuel derived from CO2 by other devices operated by the recycled energy or ratios of the fuel derived from CO2 in the recycled energy consumed by the other devices, and
the graphics data creator is further configured to create a ranking list of the amounts of the consumption of the fuel derived from CO2 by the other devices and the operational device or a ranking list of the ratios of the fuel derived from CO2 in the recycled energy consumed by the other devices and the operational device, based on the data received by the data receiver and the data collected by the data collector.

7. A display unit that urges a user of an operational device to use a recycled energy generated by burning a fuel derived from CO2 or mixing the fuel derived from CO2 with an ordinary fuel, comprising:
a controller comprising
a data collector that collects data relating to an amount of consumption of the fuel derived from CO2 by the operational device operated by the recycled energy or a ratio of the fuel derived from CO2 in the recycled energy consumed by the operational device, and data relating to an amount of consumption of the ordinary fuel by the operational device operated by the recycled energy or a ratio of the ordinary fuel in the recycled energy consumed by the operational device,
a data receiver that receives data relating to amounts of consumption of the fuel derived from CO2 by other devices operated by the recycled energy or ratios of the fuel derived from CO2 in the recycled energy consumed by the other devices, and
a graphics data creator that creates a ranking list of the amounts of the consumption of the fuel derived from CO2 by the other devices and the operational device or a ranking list of the ratios of the fuel derived from CO2 in the recycled energy consumed by the other devices and the operational device, based on the data received by the data receiver and the data collected by the data collector; and
a display that indicates the ranking list created by the graphics data creator.

8. The display unit as claimed in claim 6,
wherein the controller further comprises
a comparator that compares the amounts of the consumption of the fuel derived from CO2 by the other devices with the amount of the consumption of the fuel derived from CO2 by the operational device, or that compares the ratios of the fuel derived from CO2 in the recycled energy consumed by the other devices with the ratio of the fuel derived from CO2 in the recycled energy consumed by the operational device, and
a sorter that sorts the amounts of the consumption of the fuel derived from CO2 by the other devices and the operational device, or that sorts the ratios of the fuel derived from CO2 in the recycled energy consumed by the other devices and the operational device, and
the graphics data creator is configured to create the ranking list based on the items sorted by the sorter.

9. The display unit as claimed in claim 1, wherein the recycled energy includes an electric power generated by burning the fuel derived from CO2 and the ordinary fuel.

10. An incentive offering device that urges a user or an owner of an operational device to use a recycled energy generated by burning a fuel derived from CO2 or mixing the fuel derived from CO2 with an ordinary fuel, comprising:
a controller comprising:
a data collector that collects data relating to an amount of consumption of the fuel derived from CO2 by the operational device operated by the recycled energy or a ratio of the fuel derived from CO2 in the recycled energy consumed by the operational device, and data relating to an amount of the consumption of the ordinary fuel by the operational device operated by the recycled energy or a ratio of the ordinary fuel in the recycled energy consumed by the operational device, and
an incentive transmitter that offers an incentive to the user or the owner of the operational device in accordance with the amount of the consumption of the fuel derived from CO2 collected by the data collector, or in accordance with the ratio of the fuel derived from CO2 in the recycled energy collected by the data collector.

11. The incentive offering device as claimed in claim 10, wherein the data collector includes a calculator that calculates the amount of the consumption of the fuel derived from CO2 or the ratio of the fuel derived from CO2 in the recycled energy, and the amount of the consumption of the ordinary fuel or the ratio of the ordinary fuel in the recycled energy.

12. The incentive offering device as claimed in claim 10, wherein the data collector includes a receiver that receives the data relating to the amount of the consumption of the fuel derived from CO2 or the ratio of the fuel derived from CO2 in the recycled energy, and the data relating the amount of the consumption of the ordinary fuel or the ratio of the ordinary fuel in the recycled energy from an external source.

13. The incentive offering device as claimed in claim 10, wherein the recycled energy includes an electric power generated by burning the fuel derived from CO2 and the ordinary fuel.
